(19) United States
(12) Patent Application Publication
(10) Pub. No.: US 2003/0231598 A1
(43) Pub. Date: Dec. 18, 2003

(54) Method and apparatus for tracking data packets in a packet data communication system

(76) Inventors: Ramesh Venkataraman, Streamwood, IL (US); Bohdan L. Bodnar, Park Ridge, IL (US); Manish Watwani, Algonquin, IL (US)

Correspondence Address: MOTOROLA, INC., 1303 EAST ALGONQUIN ROAD, IL01/3RD, SCHAUMBURG, IL, 60196

(21) Appl. No.: 10/447,826

(22) Filed: May 29, 2003

Related U.S. Application Data
(60) Provisional application No. 60/389,468, filed on Jun. 18, 2002.

(51) Int. Cl. H04L 12/26

(52) U.S. Cl. 370/252

(57) ABSTRACT

A communication system that includes a mobile station (MS) in wireless communication with an infrastructure comprising a Serving GPRS Support Node (SGSN) operably coupled to a Packet Control Unit (PCU) utilizes a synchronization message conveyed by the SGSN to the PCU and a synchronization message acknowledgment conveyed by the PCU to the SGSN to determine the data provided to the MS, to provide corTect accounting information and lost data packet recovery, and to allow the SGSN to control a flow of data packets to the PCU. Furthermore, a synchronization buffer included in the SGSN stores copies of data packets conveyed by the SGSN to the PCU, allowing the SGSN to reconvey lost data packets to the serving PCU and to convey, to a target PCU, data packets conveyed by the SGSN to the serving PCU but not conveyed by the serving PCU to the MS.

### REFERENCES(S) TO RELATED APPLICATION(S)

The present application claims priority from provisional application, Serial No. 60/389,468, entitled “METHOD AND APPARATUS FOR TRACKING DATA PACKETS IN A PACKET DATA COMMUNICATION SYSTEM,” filed Jun. 18,2002, which is commonly owned and incorporated herein by reference in its entirety.

### FIELD OF THE INVENTION

The present invention relates generally to cellular communication systems, and, in particular, to data transmission protocols in a packet data communication system.

### BACKGROUND OF THE INVENTION

The General Packet Radio Service (GPRS) standard provides a compatibility standard for cellular mobile telecommunications systems. The GPRS standard ensures that a mobile station (MS) operating in a GPRS system can obtain communication services when operating in a system manufactured according to the standard. To ensure compatibility, radio system parameters and call processing procedures are specified by the standard, including call processing steps that are executed by an MS and a base station serving the MS in order to establish a call and digital control messages and analog signals that are exchanged between elements of an infrastructure that includes the base station.

FIG. 1 is a block diagram illustration of a typical GPRS communication system 100 of the prior art. Communication system 100 includes an MS 102 in communication with a first base transceiver station subsystem (BTS) 106 via an air interface 104. Typically, data is transferred between MS 102 and BTS 106 over air interface 104 pursuant to a Radio Link Control (RLC). BTS 106 is coupled to a first base station controller (BSC)108, which BSC is, in turn, coupled to a first Packet Control Unit (PCU) 110. BTS 106, BSC 108 and PCU 110 are collectively referred to as a base station subsystem (BSS). PCU 110 is coupled to a Serving GPRS Support Node (SGSN) 122 via a first Gb interface 112 that includes a bearer path between PCU 110 and the SGSN and a signaling interface. Similarly, communication system 100 further includes a second BTS 116 coupled to a second BSC 118, which BSC is, in turn, coupled to a second PCU 120. However, it is also well known in the art for a single PCU, such as PCU 110, to control multiple BTSs, such as BTSs 106 and 116. In turn, second PCU 120 is coupled to SGSN 124 via a second Gb interface 122. BTS 106, BSC 108 and PCU 110 are also collectively referred to as a BSS. BTSs 106 and 116, BSCs 108 and 118, PCUs 110 and 120, and SGSN 124 are collectively referred to as a wireless infrastructure.

When MS 102 engages in a communication session with an external network 128, data is conveyed to MS 102 via SGSN 124, PCU 110, BSC 108 and BTS 106. The data is typically included in data packets that are formatted pursuant to an Internet Protocol (IP) standard. PCU 110 typically queues the received data in a buffer included in the PCU and associated with MS 102 before conveying the data to MS 102 via BSC 108 and BTS 106. SGSN 124 monitors the number of bytes received by the SGSN from external network 128 and/or sent by the SGSN to PCU 110 and keeps a count of the number of sent and/or received bytes. SGSN 124 then conveys a count of the number of bytes sent and/or received by the SGSN to a Charging Gateway (CGW) 126 in an accounting message. A billing service then retrieves accounting records that include the byte count from CGW 126 and bills a customer associated with MS 102 a fee based on the count of the bytes count.

As MS 102 moves through communication system 100, the MS may be handed off to a second BTS, such as BTS 116, which BTS is serviced by a second BSC, such as BSC 118, and a second PCU, such as PCU 120. Typically, upon handing off MS 102 to BTS 116, BSC 118, and PCU 120, PCU 110 is instructed by SGSN 124 to delete all data stored in the buffer of the PCU associated with MS 102. Data packets may also be dropped in system 100 due to overload or congestion in the PCU, packet corruption (e.g., cyclic redundancy errors introduced in the Gb link), and so forth. In the current implementation of a GPRS system such as system 100, dropped packets are either recovered by running the Logical Link Control (LLC) protocol in the “acknowledged” mode, by relying on end-to-end protocols (such as TCP), or are not recovered at all (for example, in voice-over-IP or other real-time critical applications). Relying on these forms of dropped packet recovery increases network delay, thus reducing network-level throughput.

A resulting problem is that the byte count conveyed by SGSN 124 to CGW 126 does not reflect any data packets dropped by the infrastructure after being received by SGSN 124 from external network 124. As a result, data packets discarded by PCU 110 are not reflected in the billing of the customer associated with MS 102. Another resulting problem is that data transport protocols such as Transmission Control Protocol (TCP) and Real Audio infer that the dropped data packets are dropped due to network congestion, resulting in retransmission timeouts or multiple fast retransmit/fast recovery operations (in the case of TCP) that result in a reduction of system 100 throughput. Yet another resulting problem is that in order to assure reliable delivery of data packets from SGSN 124 to MS 102, communication system 100 typically implements a Logical Link Control (LLC) mechanism whereby MS 102 conveys an acknowledgment to SGSN 124 acknowledging correctly received data packets. The constant transmission of LLC acknowledgments consumes system 100 capacity, produces a throughput delay, and imposes a processing load upon SGSN 124.

Therefore, a need exists for a method and apparatus that reduces packet losses during a handoff (cell reselection) and other reasons, that provides for dynamic correction of accounting information, and that assures reliable delivery of data packets without implementing an LLC mechanism.

### BRIEF DESCRIPTION OF THE DRAWINGS

FIG. 1 is a block diagram of a wireless communication system of the prior art.

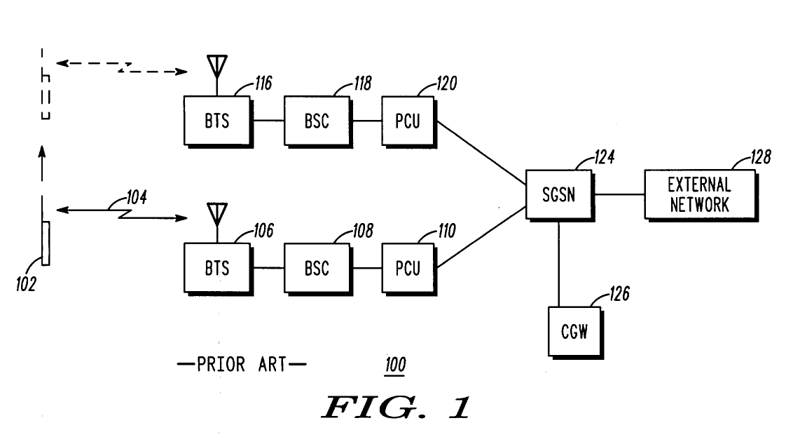

FIG. 2 is a block diagram of a wireless communication system in accordance with an embodiment of the present invention.

FIG. 3 is a logic flow diagram of steps executed by the communication system of FIG. 2 to track, or maintain a record of, data packets destined for the mobile station of FIG. 2 in accordance with an embodiment of the present invention.

FIG. 4 is a logic flow diagram of the steps executed by the communication system of FIG. 2 to control a flow of data packets in the infrastructure of FIG. 2 in accordance with another embodiment of the present invention.

FIG. 5 is a logic flow diagram of steps executed by the communication system of FIG. 2 to track, or maintain a record of, data packets destined for the mobile station of FIG. 2 when the mobile station is involved in a handoff in accordance with another embodiment of the present invention.

### DETAILED DESCRIPTION OF THE INVENTION

To address the need for a method and apparatus that reduces packet losses during a handoff (cell reselection), that provides for dynamic correction of accounting information, and that assures reliable delivery of data packets without implementing an LLC mechanism, a communication system is provided that includes a mobile station (MS) in wireless communication with an infrastructure comprising a Serving GPRS Support Node (SGSN) operably coupled to a Packet Control Unit (PCU). The communication system utilizes a synchronization message conveyed by the SGSN to the PCU and a synchronization message acknowledgment conveyed by the PCU to the SGSN to determine the data provided to the MS and to provide correct accounting information and lost data packet recovery. Utilization of the synchronization message and the synchronization message acknowledgment also allows the SGSN to control a flow of data packets to the PCU. Furthermore, a synchronization buffer included in the SGSN stores copies of data packets conveyed by the SGSN to the serving PCU, allowing the SGSN to reconvey lost data packets to the serving PCU and to convey, to a target PCU, data packets conveyed by the SGSN to the serving PCU but not conveyed by the serving PCU to the MS.

Generally, an embodiment of the present invention encompasses a method for tracking data packets by a Serving GPRS Support Node (SGSN) in a packet data communication system. The method includes steps of storing a count of a quantity of data conveyed by the SGSN, determining a quantity of data conveyed by a Packet Control Unit (PCU) to a mobile station (MS), and adjusting the count of the quantity of data conveyed by the SGSN based on the determined quantity of data conveyed by the PCU to the MS.

Another embodiment of the present invention encompasses a method for controlling a flow of data packets by an SGSN in a packet data communication system. The method includes steps of conveying at least one data packet to a PCU, receiving a message informing of a quantity of data conveyed by the PCU to a MS, and, based on the received message informing of a quantity of data conveyed by the PCU to the MS, determining to halt conveyance of data packets to the PCU.

Still another embodiment of the present invention encompasses, in a packet data communication system comprising an SGSN that is operably coupled to each network element of multiple network elements, a method for tracking data packets. The method includes steps of determining that a MS has been handed off from a first network element of the multiple network elements to a second network element of the multiple network elements and conveying a message to the first network element requesting information concerning a quantity of data conveyed by the first network element to the MS. The method further includes a step of, in response to conveying the request to the first network element, receiving a message informing of a quantity of data conveyed by the first network element to the MS.

Yet another embodiment of the present invention encompasses an SGSN that includes a memory device that stores a count of a quantity of data conveyed by the SGSN and a processor coupled to the memory device that determines a quantity of data conveyed by a PCU to a MS and adjusts the count of the quantity of data stored in the memory device based on the determined quantity of data conveyed by the PCU to the MS.

Still another embodiment of the present invention encompasses a distributed database in a packet data communication system. The distributed database includes a first buffer that is included in an SGSN and that stores a copy of a data packet conveyed by the SGSN to a PCU. The distributed database further includes a second buffer that is included in the PCU, wherein the PCU receives the data packet from the SGSN and stores the received data packet in the second buffer.

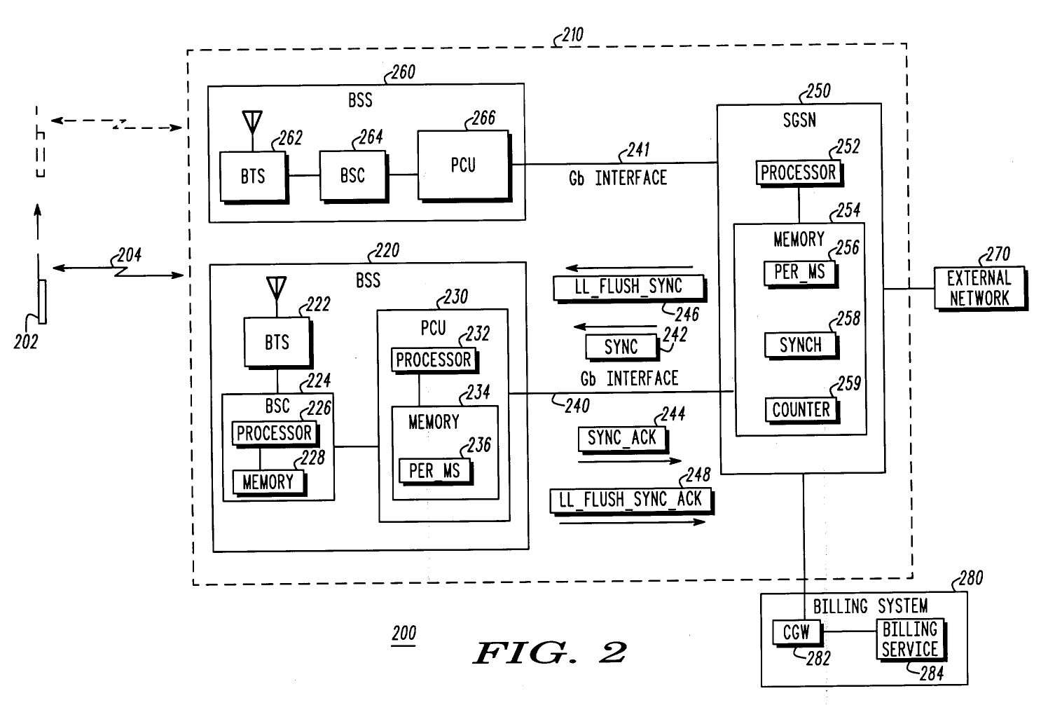

The present invention may be more fully described with reference to FIGS. 2-5. FIG. 2 is a block diagram of a wireless communication system 200 in accordance with an embodiment of the present invention. Communication system 200 includes multiple base station subsystems (BSS) 220, 260 (two shown). Each BSS 220, 260 of the multiple BSSs includes a respective base transceiver station (BTS) 222, 262 operably coupled to a respective base station controller (BSC) 224, 264, which base station controller is, in turn, operably coupled to a respective packet control unit (PCU) 230, 266. Communication system 200 further includes at least one Serving GPRS Support Node (SGSN) 259 that is coupled to each BSS 220, 260, preferably to a respective PCU 230, 266 of the BSS, by a respective Gb interface 240, 241. Each PCU 230, 266 exchanges signaling messages and bearer traffic with SGSN 250 via a respective GB interface 240, 241. However, in another embodiment of the present invention, each PCU of the multiple PCUs 230, 266 may be coupled to a different SGSN. BSSs 220 and 260, PCUs 230 and 266, and SGSN 250 are collectively referred to herein as a telecommunications infrastructure 210. Telecommunications infrastructure 210, preferably SGSN 260, is operably coupled to an external network 270 and to a billing system 280 that includes a Charging Gateway 282 in communication with a billing service 284. Communication system 200 further includes at least one mobile station (MS) 202 that is provided communication services by a BSS 220 of the multiple BSSs 220, 260. MS 202 and a BTS of the serving BSS 220, that is BTS 222, communicate via an air interface 204.

Each BSC of the multiple BSCs 224, 264 includes a processor 226 operably coupled to a memory device 228. Each PCU of the multiple PCUs 230, 266 also includes a processor 232 operably coupled to a memory device 234. Each PCU further comprises a PCU data buffer 236, preferably a per_MS buffer, that is included in memory device 234 or otherwise coupled to processor 232, that is associated with an individual MS serviced by the PCU, that is, MS 102, and that stores data packets received by the PCU from SGSN 250 and destined for the associated MS.

SGSN 250 comprises a processor 252 operably coupled to a memory device 254 and further comprises a first SGSN data buffer 256, a second SGSN data buffer 258, and a data counter 259. Each of buffers 256 and 258 and data counter 259 may reside in memory device 254 or may be located elsewhere in SGSN 250 and be in communication with processor 252. First SGSN data buffer 256 preferably is a per-MS buffer that is associated with an individual MS serviced by the SGSN, that is, MS 102, and stores data packets destined for the associated MS. The data packets may be sourced to SGSN 250 from external network 270 or may have a different source, such as an application running in processor 252 of SGSN 250. The source of the data packets stored in buffer 256 is not critical to the present invention. Second SGSN data buffer 258 preferably is a synchronization buffer that stores data packets transmitted by the SGSN to a particular MS currently controlled by or associated with PCU 230, that is, MS 202. Data counter 259 preferably is a charge counter that is also associated with an individual MS serviced by the SGSN, that is, MS 202, and that keeps a count of a quantity of data, such as a number of bytes, conveyed by the SGSN to the associated MS and/or received by the SGSN from the associated MS.

Each of processors 226, 232, and 252, comprises one or more microprocessors, microcontrollers, digital signal processors (DSPs), combinations thereof or such other devices known to those having ordinary skill in the art. Each of memory devices 228, 234, and 254, comprise one or more memory devices such as a random access memory (RAM), a dynamic random access memory (DRAM), and/or a read only memory (ROM) or equivalents thereof, that stores data and programs that may be executed by the corresponding processor.

Communication system 200 comprises a wireless packet data communication system. In order for MS 202 to establish a packet data connection with an external network such as external network 270, each of the multiple BSSs 220, 260, multiple PCUs 230, 266, and at least one SGSN 250 operates in accordance with well-known wireless telecommunications protocols. By operating in accordance with well-known protocols, a user of MS 202 can be assured that MS 202 will be able to communicate with infrastructure 210 and establish a packet data communication link with an external network, such as network 270, via infrastructure 210. Preferably, communication system 200 operates in accordance with the General Packet Radio Service (GPRS) standard. The standard specifies wireless telecommunications system operating protocols, including radio system parameters and call processing procedures. However, those who are of ordinary skill in the art realize that communication system 200 may operate in accordance with any one of a variety of wireless packet data communication systems, such as a Global System for Mobile communication (GSM) communication system, a Code Division Multiple Access (CDMA) communication system, a Time Division Multiple Access (TDMA) communication system, a Frequency Division Multiple Access (FDMA) communication system, or an Orthogonal Frequency Division Multiple Access (OFDM) communication system.

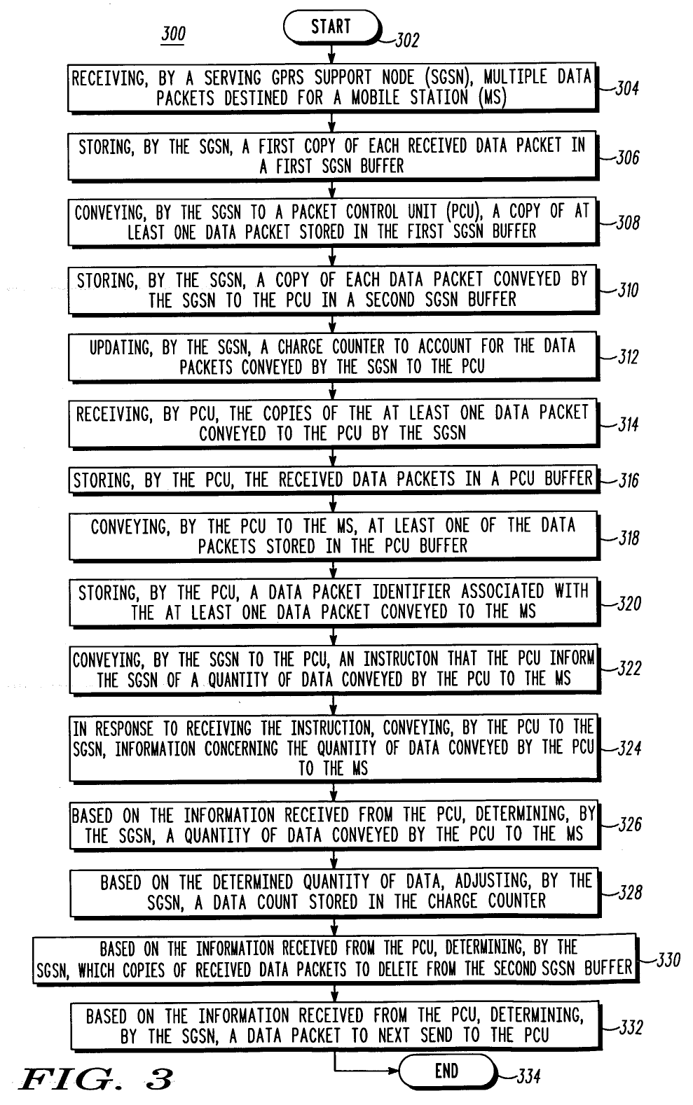

Communication system 200 avoids billing a customer associated with MS 202 for data packets that were dropped by infrastructure 210 and minimizes a message loading of the system resulting from tracking the data packets transferred to MS 102 by maintaining a record of the data packets conveyed to the MS by a PCU serving the MS, that is, PCU 230. FIG. 3 is a logic flow diagram 300 of steps executed by communication system 200, and in particular by infrastructure 210, to track, or maintain a record of, data packets destined for MS 102 in accordance with an embodiment of the present invention. Logic flow diagram 300 begins (302) when infrastructure 210, and in particular SGSN 250, receives (304) multiple data packets destined for MS 202 from external network 270. Preferably all steps performed by SGSN 250 as described with respect to logic flow diagram 300 are performed by processor 252 of the SGSN, and all steps performed by PCU 230 as described with respect to logic flow diagram 300 are performed by processor 232 of the PCU.

Upon receiving the data packets, SGSN 250 stores (306) each data packet in a queue in a first buffer, that is, per-MS buffer 256, which buffer is individually associated with MS 202. SGSN 250 then transmits (308) data packets stored in per_MS buffer 256 to a PCU serving the MS, that is, PCU 230, and, upon transmitting a packet from the per_MS buffer to the PCU, stores (310) a copy of each transmitted data packet in a second buffer, that is, synchronization buffer 258. As a result, synchronization buffer 258 stores copies of data packets that have been sent to a PCU, such as PCU 230, and for which data packets the SGSN has not received an acknowledgment, that is, a SYNC_ACK, 240 indicating that the sent packets have been conveyed to an MS serviced by the PCU, that is, MS 202. Each data packet conveyed by SGSN 250 to PCU 230 includes an identifier, or a tag, which is assigned to the packet by SGSN 250 in a strictly increasing order from one data packet to a next data packet and that uniquely identifies the data packet. Preferably, the tag is added to a header of the data packet by processor 252 of the SGSN. This tag permits the SGSN 250 and PCU 230 to uniquely identify a packet solely by looking at its tag value. Each data packet stored in synchronization buffer 258 of SGSN 250 also includes the tag associated with the packet.

Upon conveying a data packet to PCU 230, SGSN 250 updates (312) charge counter 259 to account for the data packets conveyed to PCU 230. SGSN 250 maintains a record of a quantity of data transferred to PCU 230, and thereby to MS 202, in charge counter 259 and utilizes charge counter 259 to provide a billing service 280 with an accounting of the data quantity.

When PCU 230 receives (314) a data packet from SGSN 250, PCU 230 stores (316) the data packet in a queue in per_MS buffer 236, which buffer is associated with the intended destination of the data packet, that is, MS 202. Synchronization buffer 258 in SGSN 250 can be considered to store “master copies” of the data packets conveyed by the SGSN to PCU 230, and per_MS buffer 236 in PCU 230 can be considered to store “remote copies” of the data packets conveyed by the SGSN to the PCU. In this manner, synchronization buffer 258 and per_MS buffer 236 can be considered to constitute a distributed database. PCU 230 then conveys (318) at least one of the data packets stored in the per_MS buffer 236 of the PCU to MS 102 via a serving BTS, that is, BTS 222. Preferably, PCU 230 conveys each stored data packet by retrieving the data packet from per_MS buffer 236 and conveying the retrieved data packets to MS 202. PCU 230 also stores (320) the tag associated with the most recently conveyed data packet in PCU memory device 234.

When SGSN 250 desires to be updated concerning the data packets conveyed by PCU 230 to MS 202, the SGSN conveys (322) a Gb interface synchronization message (SYNC) 242 via Gb interface 240 to the PCU. Synchronization message 242 queries PCU 230, or instructs PCU 230 to inform the SGSN, concerning a quantity of data, preferably a number of data packets, conveyed by the PCU to MS 202. In response to receiving synchronization message 242, PCU 230 informs (324) SGSN 250 of the quantity of data, preferably of the data packets, conveyed by the PCU to MS 202 by conveying a query response, preferably a Gb interface acknowledgment of the synchronization message (SYNC_ACK) 244, to the SGSN via Gb interface 240. In one embodiment of the present invention, the query response, that is, synchronization message acknowledgment 244, may inform of the number of data packets conveyed by PCU 230 to MS 202 and the data packets' associated tags, or identifiers. In another embodiment of the present invention, the query response, that is, synchronization message acknowledgment 244, may inform of the tag of the most recently conveyed data packet or message. In the latter embodiment, PCU 230 preferably conveys data packets to MS 102 in a sequential order based on the tag associated with each data packet. Based on a tag included in synchronization message acknowledgment 244, SGSN 250 is then able to determine which data packets have been conveyed to MS 102.

For example, and merely for the purpose of illustrating the principles of the present invention, suppose PCU 230 receives, in sequence, data packets with corresponding tags 1, 2, 3, and then 5. PCU 230 will convey data packets 1, 2, and 3 to MS 102 but will discard data packet 5. PCU 230 will continue to discard all subsequently received data packets until data packet 4 is received, and will then convey data packet 4 to MS 102. When PCU 230 informs SGSN 250 in a synchronization acknowledgment 244 that data packet 3 has been conveyed to MS 102, and that subsequent packets have been discarded, the SGSN may correctly infer that data packets 1, 2, and 3 have also been conveyed to MS 102. SGSN 250 then deletes copies of packets 1, 2, and 3 that are held in synchronization buffer 258 and retransmits packets 4 and 5 from the synchronization buffer. Thus, lost packets are recovered, in the proper order, from synchronization buffer 258 of SGSN 250 instead of relying on upper layer protocols. This local recovery, being faster than a reliance on upper layer protocols, improves a performance of communication system 200.

Based on synchronization acknowledgment 244, SGSN 250 determines (326) a data quantity conveyed by PCU 230 to MS 202 and adjusts (328) a data count stored in charge counter 259 accordingly. Also, based on synchronization acknowledgment 244, SGSN 250 determines (330) data packets to be deleted from synchronization buffer 258. Preferably, SGSN 250 determines to delete, and deletes, copies of data packets corresponding to the data packets that the synchronization acknowledgment 244 informs have been conveyed by PCU 230 to MS 202, thereby freeing up buffer space previously occupied by those data packets. In addition, based on synchronization acknowledgment 244, SGSN 250 may determine (332) a data packet to next send to PCU 230. Logic flow 300 then ends (334).

For example, and merely for the purpose of illustrating the principles of the present invention and not intended to limit the invention in any way, suppose SGSN 250 stores six data packets in each of the SGSN per_MS buffer 256 and synchronization buffer 258. SGSN then conveys the six data packets, with corresponding tags 1, 2, 3, 4, 5, and 6, to PCU 230 and then conveys a synchronization message, that is, a SYNC message, 242 via Gb interface 240 to the PCU. When SGSN 250 conveys the six data packets, the SGSN retrieves the data packets from the SGSN per_MS buffer 256, thereby removing the data packets from the buffer. However, the six data packets remain stored in synchronization buffer 258. Also, when SGSN 250 conveys the six data packets to PCU 230, the SGSN, preferably processor 252, adjusts charge counter 259 to indicate that the data included in the six packets has been conveyed to MS 202.

Upon receiving the six data packets from SGSN 250, PCU 230 stores the six data packets in the PCU per_MS buffer 236. PCU 230 then retrieves data packets 1 and 2 from buffer 236 and conveys data packets 1 and 2 to MS 202, and is in the process of conveying data packet 3 to MS 202 when the PCU acts upon synchronization message 242. In response to synchronization message 242, PCU 230 conveys a synchronization acknowledgment, that is, a SYNC_ACK message, 244 to SGSN 250 via Gb interface 240 that acknowledges receipt of synchronization message 242 and informs either that data packets 1 and 2 have been conveyed to MS 202 or that data packet 2 was the last data packet conveyed by the PCU to the MS. In response to receiving synchronization acknowledgment 244, SGSN 250 then adjusts the information stored in charge counter 259 to correctly reflect that only data packets 1 and 2 have been conveyed to MS 202 and deletes the corresponding copies of data packets 1 and 2 from synchronization buffer 258.

When a reliable protocol, such as Radio Link Control (RLC) protocol operating in an acknowledged mode, is used for the transmission of the data packets from BSS 220 to MS 202 via air interface 204, communication system 200 is able to provide correct charging information to billing service 280 without the need to run Logical Link Control (LLC) in an acknowledged mode between MS 202 and SGSN 250. Since the air interface protocols terminate at PCU 230, in contrast to LLC that terminates at SGSN 250, a dispensing with LLC results in a reduced system delay and a higher system throughput. Furthermore, a dispensing with LLC also reduces a loading of the Gb interface 236, resulting in a saving in system capacity and reduction in the processing load of the SGSN since the SGSN does not have to constantly process LLC acknowledgments.

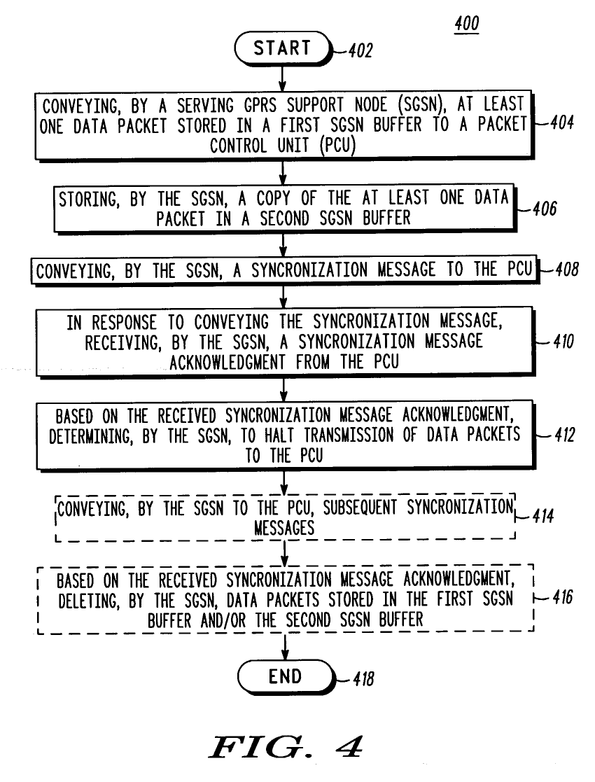

In another embodiment of the present invention, synchronization message that is, SYNC, 242 and synchronization message acknowledgment, that is, SYNC-ACK, 244 may be used to control a data packet flow between SGSN 250 and PCU 230. FIG. 4 is a logic flow diagram 400 of the steps executed by communication system 200, and in particular by infrastructure 210, to control a flow of data packets in the infrastructure. Logic flow diagram 400 begins (402) when SGSN 250 conveys (404) at least one data packet stored in a first SGSN buffer, that is, per_MS buffer 256, to PCU 230. Preferably all steps performed by SGSN 250 as described with respect to logic flow diagram 400 are performed by processor 252 of the SGSN, and all steps performed by PCU 230 as described with respect to logic flow diagram 400 are performed by processor 232 of the PCU. Upon conveying the at least one data packet to PCU 230, SGSN 250 stores (406) a copy of the at least one data packet in a second SGSN buffer, that is, synchronization buffer 258. Each data packet conveyed by SGSN 250 to PCU 230 includes an identifier, or a tag, which is assigned to the packet by SGSN 250 in a strictly increasing order from one data packet to a next data packet and that uniquely identifies the data packet. Each data packet stored in synchronization buffer 258 of SGSN 250 also includes the tag associated with the packet. Again, by storing “master copies” of the data packets conveyed by the SGSN to PCU 230 in synchronization buffer 258 and storing “remote copies” of the data packets in per_MS buffer 236 in PCU 230, synchronization buffer 258 and per_MS buffer 236 can be considered to constitute a distributed database.

After conveying the at least one data packet to PCU 230, SGSN 250 conveys (408) a synchronization message that is, a SYNC message, 242 to the PCU. In response to conveying synchronization message 242, SGSN 250 receives (410) a synchronization message acknowledgment, that is, a SYNC_ACK message, 244 from PCU 230. As noted above, synchronization acknowledgment 244 may inform of the number of data packets conveyed by PCU 230 to MS 202 and the data packets' associated tags, or identifiers, or may inform of the tag of the most recently conveyed message. However, in yet another embodiment of the present invention, SGSN may receive a synchronization acknowledgment 244 from PCU 230 without first conveying a synchronization message 242 to the PCU, as the PCU may self-initiate a conveyance of a synchronization acknowledgment 244.

Based on the synchronization acknowledgment 244 received from PCU 230, SGSN 250 can then halt (412) transmission of data packets to PCU 230, and the logic flow ends (418). For example, when the synchronization acknowledgment 244 includes a tag that is the same as a tag included in an earlier synchronization acknowledgment, such as SGSN 250 receiving the same tag in two successive synchronization acknowledgments, and SGSN 250 knows that per_MS buffer 236 of PCU 230 is not empty, then the SGSN may infer that conveyance of data packets downstream from the SGSN is stalled and halt conveyance of data packets to PCU 230 from per_MS buffer 256. By way of another example, SGSN 250 can track the size of per_MS buffer 236 of PCU 230 based on the synchronization acknowledgment 244 received from PCU 230 by knowing the size of the data packets transmitted by the SGSN to the PCU and the tag of the last packet sent by the SGSN to the PCU. When SGSN 250 determines that the size of per_MS buffer 236 reaches a predetermined value, which predetermined value preferably is stored in memory device 254, the SGSN can halt conveyance of data packets to PCU 230 from per_MS buffer 256. However, the SGSN may still convey (414) synchronization messages 242 to PCU 230 notwithstanding the halt in the conveyance of data packets to the PCU. In still another embodiment of the present invention, based on the synchronization message acknowledgment 244 received from PCU 230, SGSN 250 may also delete (416) from buffers 256 and/or 258 any data packets still stored in the buffer and acknowledged by PCU 230, thereby freeing up the buffer or buffers to store more data.

By utilizing synchronization message, that is, SYNC message, 242 to request, by SGSN 250, information concerning data packets conveyed by PCU 230 to MS 202, and by utilizing synchronization message acknowledgment, that is, SYNC_ACK message, 244 to provide the requested information, SGSN 250 is able to determine the data provided to MS 202 and is able to provide correct charging information to billing service 280 without the need to run Logical Link Control (LLC) in an acknowledged mode between MS 202 and SGSN 250. A dispensing with LLC results in a reduced system delay, a higher system throughput, and a reduced loading of the Gb interface 236 and SGSN 250. In addition, utilization of synchronization message 242 and synchronization message acknowledgment 244 allows SGSN 250 to control the flow of data packets to PCU 230 to avoid overwhelming the PCU with data packets. Furthermore, by providing a synchronization buffer 258 in SGSN 250 that stores copies of data packets conveyed by the SGSN to PCU 230, the SGSN is easily able to reconvey lost data packets to PCU 230.

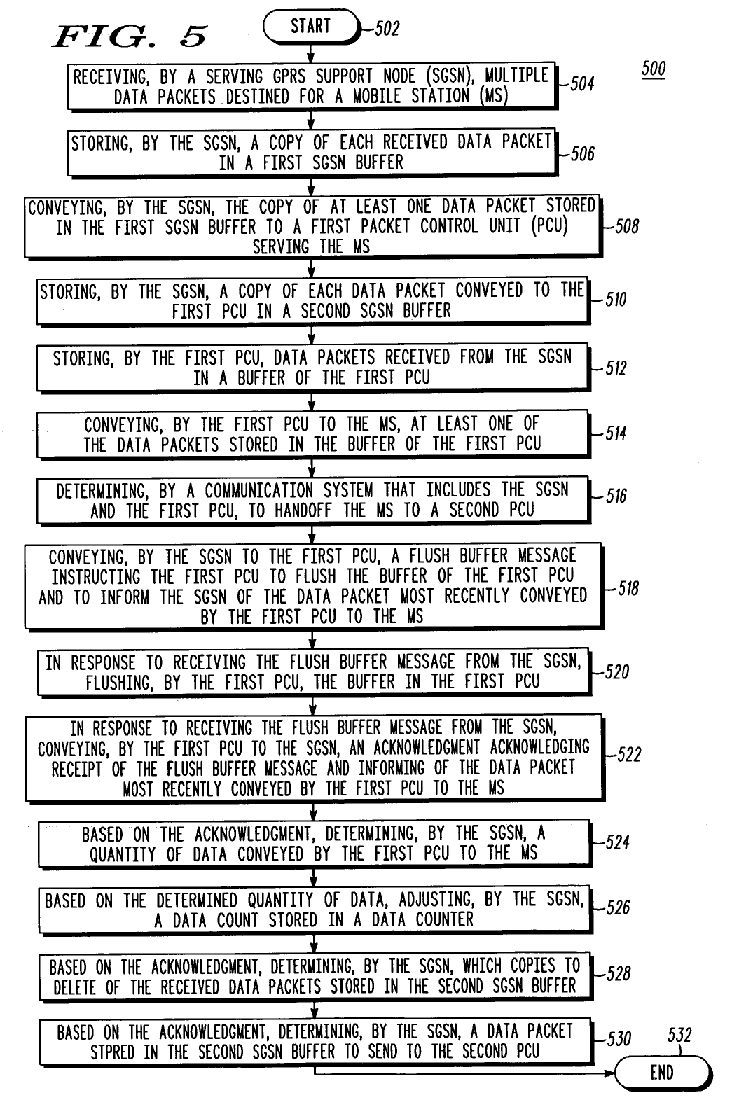

In addition to utilizing the synchronization message 242 and synchronization acknowledgment 244 to preventing a billing of a customer associated with MS 202 for data packets that were dropped by infrastructure 210 and to reducing delays and a loading of communication system 200, communication system 200 utilizes synchronization message 242 and synchronization acknowledgment 244 to minimize data packet losses during handoff of MS 202 from BSS 220 and PCU 230 to BSS 260 and PCU 266. FIG. 5 is a logic flow diagram 500 of steps executed by communication system 200 in tracking data packets destined for MS 202 when the MS is involved in a handoff in accordance with an embodiment of the present invention.

Logic flow diagram 500 begins (502) when SGSN 250 receives (504) multiple data packets destined for MS 202. Preferably all steps performed by SGSN 250 as described with respect to logic flow diagram 500 are performed by processor 252 of the SGSN, and all steps performed by PCU 230 as described with respect to logic flow diagram 500 are performed by processor 232 of the PCU. SGSN 250 stores (506) each data packet of the multiple data packets in each of a first SGSN buffer, that is, per_MS buffer 256, which buffer is individually associated with MS 202. SGSN 250 then conveys (508) each stored data packet to a PCU serving MS 202, that is, PCU 230, by retrieving each data packet stored in per_MS buffer 256 of the SGSN and conveying the retrieved data packets to serving PCU 230. Each of the conveyed packets has attached to it a unique tag. Upon transmitting a packet from the per_MS buffer to serving PCU 230, SGSN 250 stores (510) a copy of each transmitted data packet in a second SGSN buffer, that is, synchronization buffer 258, which stored data packets include the tag that is uniquely associated with the packet. Upon receiving the data packets from SGSN 250, serving PCU 230 stores (512) the received data packets in per_MS buffer 236 of PCU 230, which buffer is individually associated with MS 202. PCU 230 then conveys (514) to MS 202 at least one data packets stored in per_MS buffer 236 of PCU 230, preferably by retrieving the data packets from the buffer and transmitting the data packets to the MS via a BTS serving the MS, that is, BTS 222. Again, by storing “master copies” of the data packets conveyed by the SGSN to PCU 230 in synchronization buffer 258 and storing “remote copies” of the data packets in per_MS buffer 236 in PCU 230, synchronization buffer 258 and per_MS buffer 236 can be considered to constitute a distributed database.

Prior to SGSN 250 conveying to serving PCU 230 all data packets received by the SGSN and destined for MS 202, and prior to serving PCU 230 conveying to MS 202 all data packets received by the serving PCU from SGSN 250 and destined for MS 202, communication system 200 determines (516) to handoff MS 202, or transfer the communication services being provided to MS 202, to a second, target BSS and PCU, such as BSS 260 and PCU 266. As a result, at least one data packet received by serving PCU 230 from SGSN 250 and destined for MS 202 remains stored in the per_MS buffer 236 of PCU 230.

In a prior art communication system, such as communication system 100, when an MS, such as MS 102, is handed off from a first, serving PCU, such as PCU 110, to a second, target PCU, such as PCU 120, an SGSN, such as SGSN 124, conveys an LL_FLUSH message to serving PCU 110 instructing the serving PCU 110 to flush a per_MS buffer associated with the MS. In response to receiving the LL_FLUSH message, serving PCU 110 deletes all data packets stored in the per_MS buffer associated with MS 102. SGSN 124 merely stores a record of all data packets destined for MS 102 that are conveyed by the SGSN to serving PCU 110 and does not adjust the record to account for the data packets subsequently deleted by the PCU and never transmitted to the MS. As a result, a billed party associated with MS 102 is billed by a service provider for all data packets stored in PCU 110 at the time of handoff and then deleted by the PCU. When the deleted data packets are subsequently conveyed by SGSN 124 to second, target PCU 120 for conveyance to MS 102, the SGSN counts these data packets a second time, with the result that the billed party associated with the MS is billed a second time by the service provider for the same data packets that were deleted in PCU 110. In addition, the retransmission of the deleted data packets may produce time out problems and a reduction in system throughput since a system protocol such as TCP or Real Audio is not aware of the reason for the retransmission and assumes that the retransmission is due to system congestion.

In order to address the problems of double billing, data packet time outs, and system throughput reductions, when MS 202 is handed off from a first, serving PCU, that is, PCU 230, to a second, target PCU, that is, PCU 266, SGSN 250 conveys (518) a Gb interface flush buffer message 246 to serving PCU 230 via Gb interface 240. The Gb interface flush buffer message 246 message instructs serving PCU 230 to flush the per_MS buffer 236 associated with MS 202 and further queries of the serving PCU, or instructs the serving PCU to inform the SGSN, of the data packet most recently conveyed by the serving PCU to MS 202. Preferably, flush buffer message 246 is a modified version of the LL_FLUSH message of the prior art, that is, an LL_FLUSH_SYNC message, which message is modified to include the request that the PCU to inform the SGSN of the last data packet conveyed by the PCU to MS 202. Alternatively, SGSN 250 may send an LL_FLUSH message followed by a SYNC message 242.

In response to receiving flush buffer message 246, serving PCU 230 flushes (520) the per_MS buffer 236 associated with MS 202 and conveys (522) to SGSN 250 a query response, that is, a Gb interface acknowledgement message 248, preferably an LL_FLUSH_SYNC_ACK message, via Gb interface 240. Alternatively, the serving PCU can first send the LL_FLUSH_ACK and then send a separate SYNC_ACK 244. The Gb interface acknowledgement message 248 acknowledges receipt of flush buffer message 246 and informs of the data packet most recently conveyed by the PCU to MS 202. Based on acknowledgement message 248, SGSN 250, preferably processor 252, determines (524) a quantity of data, preferably a number of bytes or data packets, conveyed by serving PCU 230 to MS 202, and adjusts (526) a data count stored in charge counter 259 accordingly. Also, based on acknowledgement message 248, SGSN 250, preferably processor 252 of SGSN 250, determines (528) data packets to be deleted from synchronization buffer 258. Preferably, SGSN 250 determines to delete, and deletes, copies of data packets corresponding to the data packets that acknowledgement message 248 informs have been conveyed by PCU 230 to MS 202. In addition, based on acknowledgement message 248, SGSN 250 determines (530) a data packet to send to target PCU 266. Preferably, SGSN 250 determines to send to target PCU 266 a data packet that is next, in sequence, after the data packet most recently conveyed by serving PCU 230 to MS 202, which data packet remains stored in synchronization buffer 258. Logic flow 500 then ends (532).

For example, and merely for the purpose of illustrating the principles of the present invention and not intended to limit the invention in any way, suppose SGSN 250 stores six data packets in each of the SGSN per_MS buffer 256. SGSN then conveys the six data packets, with corresponding tags 1, 2, 3, 4, 5, and 6, to serving PCU 230, and stores copies of the tagged packets sent to PCU 230 in synchronization buffer 258. When SGSN 250 conveys the six data packets, the SGSN retrieves the data packets from the SGSN per_MS buffer 256, thereby removing the data packets from the buffer. However, the six data packets remain stored in synchronization buffer 258. Also, when SGSN 250 conveys the six data packets to serving PCU 230, the SGSN, preferably processor 252, adjusts charge counter 259 to indicate that the data included in the six packets has been conveyed to MS 202.

Upon receiving the six data packets from SGSN 250, serving PCU 230 stores the six data packets in the PCU per_MS buffer 236. PCU 230 then retrieves data packets 1 and 2 from buffer 236 and conveys data packets 1 and 2 to MS 202, and is in the process of retrieving data packet 3 when the serving PCU receives an LL_FLUSH_SYNC message 246. In response to receiving LL_FLUSH_SYNC message 246, serving PCU 230 flushes per_MS buffer 236 of the remaining data packets 3, 4, 5, and 6 still stored in the buffer and conveys a LL_FLUSH_SYNC_ACK message 248 to SGSN 250. LL_FLUSH_SYNC_ACK message 248 acknowledges receipt of LL_FLUSH_SYNC message 246 and informs that data packet 2 was the last data packet conveyed by the serving PCU to MS 202 and that packets following packet 2 have been deleted. In response to receiving LL_FLUSH_SYNC_ACK message 248, SGSN 250 then adjusts the information stored in charge counter 259 to reflect that only data packets 1 and 2 have been conveyed to MS 202 and deletes the corresponding copies of data packets 1 and 2 from synchronization buffer 258. In addition, based on LL_FLUSH_SYNC_ACK message 248, SGSN 250 determines to convey data packets 3, 4, 5, and 6 to target PCU 266 for transmission to MS 202, which data packets are stored in synchronization buffer 258. In the event that data packet 3 is conveyed to MS 202 by serving PCU 230 and is not acknowledged by PCU 230 to SGSN 250, MS 202 may merely receive the data packet twice and will simply ignore the second received copy.

By use of a flush buffer message, that is, an LL_FLUSH_SYNC message 246 conveyed by the SGSN 250 to a serving PCU 230 and a Gb interface acknowledgement message, that is, an LL_FLUSH SYNC_ACK message, 248 conveyed by the serving PCU to the SGSN, communication system 200, and in particular SGSN 250, is able to determine the data provided to MS 202 by the serving PCU and to determine the appropriate data packets to convey to a target PCU 266 during a handoff of the MS. Furthermore, storage of data packets conveyed by the SGSN 250 to serving PCU 230 PCU in synchronization buffer 258 allows the SGSN to easily convey to target PCU 266 data packets conveyed by the SGSN to the serving PCU but not conveyed by the serving PCU to the MS.

In sum, communication system 200 utilizes a synchronization message, preferably either a SYNC message or an LL_FLUSH_SYNC message that includes a synchronization message, conveyed by SGSN 250 to PCU 230 and a synchronization message acknowledgment, preferably either a SYNC_ACK message or an LL_FLUSH_SYNC_ACK message, conveyed by PCU 230 to SGSN 250, to determine information concerning data packets conveyed by PCU 230 to MS 202. Based on the synchronization message and the synchronization message acknowledgment, communication system 200, preferably SGSN 250, is able to keep an accurate accounting of the data packets conveyed by infrastructure 210 to MS 210 and to control a flow of data packets to a serving PCU 230 and a target PCU 266. In addition, by storing data packets conveyed by the SGSN 250 to serving PCU 230 PCU in synchronization buffer 258 in SGSN 250, the SGSN can easily reconvey lost data packets to a serving PCU 230 and can convey, to target PCU 266, data packets conveyed by the SGSN to the serving PCU but not conveyed by the serving PCU to MS 202.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for tracking data packets by a Serving GPRS Support Node (SGSN) in a packet data communication system comprising steps of:
storing a count of a quantity of data conveyed by the SGSN;
determining a quantity of data conveyed by a Packet Control Unit (PCU) to a mobile station (MS); and
adjusting the count of the quantity of data conveyed by the SGSN based on the determined quantity of data conveyed by the PCU to the MS.

2. The method of claim 1, further comprising steps of:
receiving a data packet;
storing the data packet in a first buffer; and
upon transmission out of the first buffer, storing a copy of the data packet in a second buffer.

3. The method of claim 2, further comprising steps of:
retrieving the first copy of the data packet from the first buffer;
conveying the retrieved data packet to the Packet Control Unit (PCU); and
wherein the step of determining a quantity of data conveyed by a Packet Control Unit (PCU) to a mobile station (MS) comprises a step of determining whether the data packet conveyed to the PCU has been conveyed by the PCU to the MS.

4. The method of claim 3, further comprising a step of, upon determining that the data packet conveyed to the PCU has been conveyed by the PCU to the MS, deleting the data packet from the second buffer.

5. The method of claim 1, wherein the step of determining a quantity of data conveyed by a Packet Control Unit (PCU) to a mobile station (MS) comprises steps of:
conveying a message to the PCU requesting information concerning a quantity of data conveyed by the PCU to the MS; and
in response to conveying the request to the PCU, receiving a message informing of a quantity of data conveyed by the PCU to the MS.

6. The method of claim 5, wherein the message informing of a quantity of data conveyed by the Packet Control Unit (PCU) to the mobile station (MS) identifies a data packet most recently conveyed by the PCU to the MS.

7. The method of claim 6, wherein the message informing of a quantity of data conveyed by the Packet Control Unit (PCU) to the mobile station (MS) is a query response message.

8. The method of claim 5, wherein the message informing of a quantity of data conveyed by the Packet Control Unit (PCU) to the mobile station (MS) identifies a plurality of data packets conveyed by the PCU to the MS.

9. The method of claim 8, wherein the message informing of a quantity of data conveyed by the Packet Control Unit (PCU) to the mobile station (MS) is a query response message.

10. A method for controlling a flow of data packets by a Serving GPRS Support Node (SGSN) in a packet data communication system comprising steps of:
conveying at least one data packet to a packet control function (PCU);
receiving a message informing of a quantity of data conveyed by the PCU to a mobile station (MS);
based on the received message informing of a quantity of data conveyed by the PCU to the MS, determining to halt conveyance of data packets to the PCU.

11. The method of claim 10, further comprising a step of, in response to receiving the message informing of a quantity of data conveyed by the packet control unit (PCU) to the mobile station (MS), deleting data stored in a buffer of the Serving GPRS Support Node.

12. The method of claim 10, wherein the message informing of a quantity of data conveyed by the Packet Control Unit (PCU) to the mobile station (MS) comprises a second message, wherein the method further comprises a step of conveying a first message to the PCU requesting information concerning a quantity of data conveyed by the PCU to the MS, and wherein the second message is received in response to conveyance of the first message.

13. The method of claim 10, wherein the step of determining to halt conveyance of data packets to the Packet Control Unit (PCU) comprises steps of:
determining that a conveyance of data packets downstream from the Serving GPRS Support Node (SGSN) is stalled; and
determining to halt conveyance of data packets to the PCU.

14. The method of claim 10, wherein the Packet Control Unit (PCU) comprises a PCU buffer that stores data packets received by the PCU from the Serving GPRS Support Node (SGSN), and wherein the step of determining to halt conveyance of data packets to the Packet Control Unit (PCU) comprises steps of:
determining that the PCU buffer has reached a predetermined size; and
determining to halt conveyance of data packets to the PCU.

15. In a packet data communication system comprising a Serving GPRS Support Node (SGSN) that is operably coupled to each network element of a plurality of network elements, a method for tracking data packets comprising steps of:
determining that a mobile station (MS) has been handed off from a first network element of the plurality of network elements to a second network element of the plurality of network elements;
conveying a message to the first network element requesting information concerning a quantity of data conveyed by the first network element to the MS; and
in response to conveying the request to the first network element, receiving a message informing of a quantity of data conveyed by the first network element to the MS.

16. The method of claim 15, further comprising steps of:
storing a count of a quantity of data conveyed by the Serving GPRS Support Node (SGSN); and
in response to receiving the message informing of a quantity of data conveyed by the first network element to the mobile station (MS), adjusting the count of the quantity of data conveyed by the SGSN.

17. The method of claim 15, wherein the message informing of a quantity of data conveyed by the first network element to the mobile station (MS) identifies at least one data packet conveyed by first network element to the mobile station MS, and wherein the method further comprises steps of:
storing a plurality of data packets; and
conveying at least one data packet of the plurality of stored data packets to the second network element based on the at least one data packet identified as conveyed by first network element to the mobile station MS.

18. The method of claim 15, wherein the at least one data packet of the plurality of stored data packets conveyed to the second network element is a data packet previously conveyed to the first network element.

19. A Serving GPRS Support Node (SGSN) comprising:
a memory device that stores a count of a quantity of data conveyed by the SGSN; and
a processor coupled to the memory device that determines a quantity of data conveyed by a Packet Control Unit (PCU) to a mobile station (MS) and adjusts the count of the quantity of data stored in the memory device based on the determined quantity of data conveyed by the PCU to the MS.

20. The Serving GPRS Support Node (SGSN) of claim 19, wherein the memory device comprises a plurality of buffers, and wherein the processor further receives a data packet, stores a first copy of the data packet in a first buffer of the plurality of buffers, conveys the first copy of the data packet to the packet control function (PCU), and, in response to conveying the copy of the data packet to the PCU, stores a second copy of the data packet in a second buffer of the plurality of buffers.

21. The Serving GPRS Support Node (SGSN) of claim 20, wherein the processor further determines a quantity of data conveyed by the PCU to the MS by determining whether the data packet conveyed to the PCU has been conveyed by the PCU to the MS.

22. The Serving GPRS Support Node (SGSN) of claim 21, wherein the processor further, upon determining that the data packet conveyed to the PCU has been conveyed by the PCU to the MS, deletes the data packet from the second buffer.

23. The Serving GPRS Support Node (SGSN) of claim 19, wherein the processor determines a quantity of data conveyed by the Packet Control Unit (PCU) to the mobile station (MS) by conveying a message to the PCU instructing the PCU to inform the SGSN information concerning a quantity of data conveyed by the PCU to the MS, and, in response to conveying the instruction to the PCU, receiving a message informing of a quantity of data conveyed by the PCU to the MS.

24. The Serving GPRS Support Node (SGSN) of claim 23, wherein the message informing of a quantity of data conveyed by the Packet Control Unit (PCU) to the mobile station (MS) identifies a data packet most recently conveyed by the PCU to the MS.

25. The Serving GPRS Support Node (SGSN) of claim 19, wherein the Packet Control Unit (PCU) comprises a first PCU and wherein the processor further determines that the mobile station (MS) has been handed off from the first PCU to a second PCU, conveys a message to the first PCU requesting information concerning a quantity of data conveyed by the first PCU to the MS, receives, in response to conveying the request to the PCU, a message informing of a data packet most recently conveyed by the first PCU to the MS, and determines a data packet to convey to the second PCU based on the message informing of a data packet most recently conveyed by the first PCU to the MS.

26. The Serving GPRS Support Node (SGSN) of claim 19, wherein the processor receives a message informing of a quantity of data conveyed by the packet control function (PCU) to the MS and, in response to receiving the message from the PCU, determines to halt conveyance of data packets to the PCU.

27. A distributed database in a packet data communication system comprising:
a first buffer that is included in a Serving GPRS Support Node (SGSN) and that stores a copy of a data packet conveyed by the SGSN to a Packet Control Unit; and
a second buffer that is included in the Packet Control Unit (PCU), wherein the PCU receives the data packet from the SGSN and stores the received data packet in the second buffer.

28. The distributed database of claim 27, wherein the first buffer comprises a synchronization buffer and the second buffer comprises a per_MS buffer.
